(19) United States
(12) Patent Application Publication
(10) Pub. No.: US 2015/0193634 A1
(43) Pub. Date: Jul. 9, 2015

(54) IMAGE PROCESSING APPARATUS AND CONTROL METHOD THEREOF

(71) Applicant: SAMSUNG ELECTRONICS CO., LTD., Suwon-si (KR)

(72) Inventor: Seong-gyu KIM, Suwon-si (KR)

(73) Assignee: SAMSUNG ELECTRONICS CO., LTD., Suwon-si (KR)

(21) Appl. No.: 14/587,749

(22) Filed: Dec. 31, 2014

(30) Foreign Application Priority Data
Jan. 3, 2014 (KR) 10-2014-0000565

(51) Int. Cl. G06F 21/62; H04L 9/30; H04L 9/32

(52) U.S. Cl. CPC G06F 21/62; H04L 9/3226; H04L 9/3006

(57) ABSTRACT

An image processing apparatus and control method are provided. An image processing apparatus includes: a data processor configured to process data; a storage configured to store the data and a preset first password, and configured to be converted from a locked mode which denies the data processor access to the storage to an unlocked mode which permits the data processor to access the storage so that the data can be processed if a second password which is received matches the first password; and a controller configured to include a controller memory configured to store the second password, and transmit the second password to the storage, wherein the controller encrypts the second password with a preset public key based on a public key encryption algorithm and transmits the encrypted second password to the storage

### CROSS-REFERENCE TO RELATED APPLICATION

This application claims priority from Korean Patent Application No. 10-2014-0000565, filed on Jan. 3, 2014 in the Korean Intellectual Property Office, the disclosure of which is incorporated herein by reference in its entirety.

### BACKGROUND

1. Field

Apparatuses and methods consistent with the exemplary embodiments relate to an image processing apparatus, in which image data which is received from an external device or is previously stored is processed in order to be displayed as an image, and a control method thereof. More particularly, exemplary embodiments relate to an image processing apparatus, which is in a secure structure for accessing a storage and is internally provided in the apparatus and storing image data, and a control method thereof.

2. Related Art

An image processing apparatus processes an image signal and/or image data which is received externally in accordance with a variety of types of image processing. The image processing apparatus displays the processed image data as an image on its display panel, or outputs the processed image data to a display apparatus having a display panel so that the display apparatus can display the received image data as the image. That is, the image processing apparatus may have a display panel or may not have a display panel as long as it can process the image data. For example, an image processing apparatus with a display panel can be a television (TV), and an image processing apparatus without a display panel can be a set-top box.

The image processing apparatus not only processes the image data received from an external device data in real time, but also stores the image data in an internal storage so that the image data stored in the storage can be processed any time a user wants to process the image data. With current technology, high performances of the image processing apparatus and communication environments have been achieved. Therefore, the image data which is being currently serviced can be high quality image data such as full high definition (HD) and high bitrate data. Accordingly, the storage of the image processing apparatus has to have a nonvolatile large-capacity memory. For example, a hard disk drive using an advanced technology attachment (ATA) standard interface has been mostly used.

However, such a storage can be accessed by a processor or an external device in the image processing apparatus without any specified limit. In this case, an unauthorized third-party may acquire the data stored in the storage. Accordingly, there is a need for a secure structure for restricting access to the storage so that leakage of the data stored in the storage can be prevented.

### SUMMARY

According to an aspect of an exemplary embodiment, there is provided an image processing apparatus including a data processor configured to process data; a storage configured to store the data and a preset first password, and configured to be converted from a locked mode which denies the data processor access to the storage to an unlocked mode which permits the data processor to access the storage so that the data can be processed if a second password which is received matches the first password; and a main controller comprising a controller memory configured to store the second password, and transmit the second password to the storage so that the storage can be converted from the locked mode to the unlocked mode, wherein the main controller encrypts the second password with a preset public key based on a public key encryption algorithm and transmits the encrypted second password to the storage so that the storage which has a private key corresponding to the public key can decrypt the encrypted second password with the private key.

The storage may further include a storage controller configured to control operations of the storage in response to a command from the main controller, and the storage controller may control the second password which is decrypted from the encrypted second password to be stored as the first password if the storage does not store the first password and the encrypted second password is received from the main controller, and may control the storage to enter the locked mode.

The storage controller may maintain the locked mode of the storage if the decrypted second password does not match the first password.

The main controller may delete the encrypted second password after the encrypted second password is transmitted to the storage if the encrypted second password is generated based on the second password stored in the controller memory.

The public key encryption algorithm may include a Rivest-Shamir-Adleman (RSA) method or an elliptic curve cryptosystem (ECC) method.

The controller may generate the second password based on system intrinsic information of the image processing apparatus.

The system intrinsic information may include at least one among central processing unit identification (CPU ID) of the main controller, media access control (MAC) address of the image processing apparatus, and a serial number of the image processing apparatus.

The main controller may generate a pre-password from the system intrinsic information of the image processing apparatus, and may convert the pre-password into the second password based on data encryption standard (DES) or an advanced encryption standard (AES).

The controller and the data processor may have access to the storage through an advanced technology attachment (ATA) standard interface.

According to an aspect of another exemplary embodiment, a method of controlling an image processing apparatus including a storage configured to store data and a preset first password, a data processor configured to access the storage and process the data, and a main controller configured to control an operation mode of the storage is provided. The method includes: operating by the storage, in a locked mode in which access by the data processor to the storage is denied; transmitting, by the main controller, a previously stored second password to the storage; entering, by the storage, an unlocked mode which permits the access by the data processor to the storage so that the data can be processed if the second password matches the first password; and accessing by the data processor, the storage which is in the unlocked mode and processing the data stored in the storage, wherein the main controller transmits the previously stored second password to the storage by encrypting the second password with a preset public key based on a public key encryption algorithm, and wherein the storage is converted from the locked mode into the unlocked mode when the storage having a private key corresponding to the public key decrypts the encrypted second password with the private key.

The method may further including: storing the second password decrypted from the encrypted second password as the first password if the storage does not store the first password and the encrypted second password is received from the main controller, and controlling the storage to enter the locked mode.

The method may further including: maintaining the locked mode of the storage if the decrypted second password does not match the first password.

The transmitting the previously stored second password to the storage by the main controller may further include: deleting the encrypted second password from the main controller after the main controller transmits the encrypted second password to the storage.

The public key encryption algorithm may include an Rivest-Shamir-Adleman (RSA) method or an elliptic curve cryptosystem (ECC) method.

The method may further including: generating by the main controller, the second password based on system intrinsic information of the image processing apparatus.

The system intrinsic information may include at least one of a central processing unit identification (CPU ID) of the main controller, a media access control (MAC) address of the image processing apparatus, and a serial number of the image processing apparatus.

The generating the second password by the main controller based on the system intrinsic information of the image processing apparatus may include: generating a pre-password from the system intrinsic information of the image processing apparatus; and converting the pre-password into the second password based on a data encryption standard (DES) or an advanced encryption standard (AES).

The main controller and the data processor may have access to the storage through an advanced technology attachment (ATA) standard interface.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 illustrates an example of an image processing apparatus according to a first exemplary embodiment;

FIG. 2 is a block diagram of the image processing apparatus of FIG. 1, according to an exemplary embodiment;

FIG. 3 is a block diagram showing how a main controller accesses a storage in the display apparatus of FIG. 1, according to an exemplary embodiment;

FIG. 4 shows an example of generating a password for setting a storage to a locked mode by a main controller in a display apparatus according to an exemplary embodiment;

FIG. 5 is a flowchart showing an example of encrypting and decrypting data by a Rivest-Shamir-Adleman (RSA) method, according to an exemplary embodiment;

FIG. 6 shows an example of a storage which enters a locked mode in the display apparatus of FIG. 4 as the storage of an unlimited mode receives and stores the password, according to an exemplary embodiment;

FIG. 7 shows operations performed between the main controller and a storage controller when the storage in the display apparatus of FIG. 4 enters the locked state, according to an exemplary embodiment;

FIG. 8 is a flowchart showing a process where the main controller in the display apparatus of FIG. 4 accesses the storage in the locked state, according to an exemplary embodiment; and

FIG. 9 is a flowchart showing a process where the storage controller in the display apparatus of FIG. 4 accepts or refuses a request for access by the main controller of the storage in the locked state, according to an exemplary embodiment.

### DETAILED DESCRIPTION OF EXEMPLARY EMBODIMENTS

Exemplary embodiments will be described in detail with reference to accompanying drawings. In the following exemplary embodiments, only elements directly related to the exemplary embodiment will be described, and descriptions about the other elements will be omitted. However, it will be appreciated that the elements, the descriptions of which are omitted, are not unnecessary to realize the apparatus or system according to the exemplary embodiments.

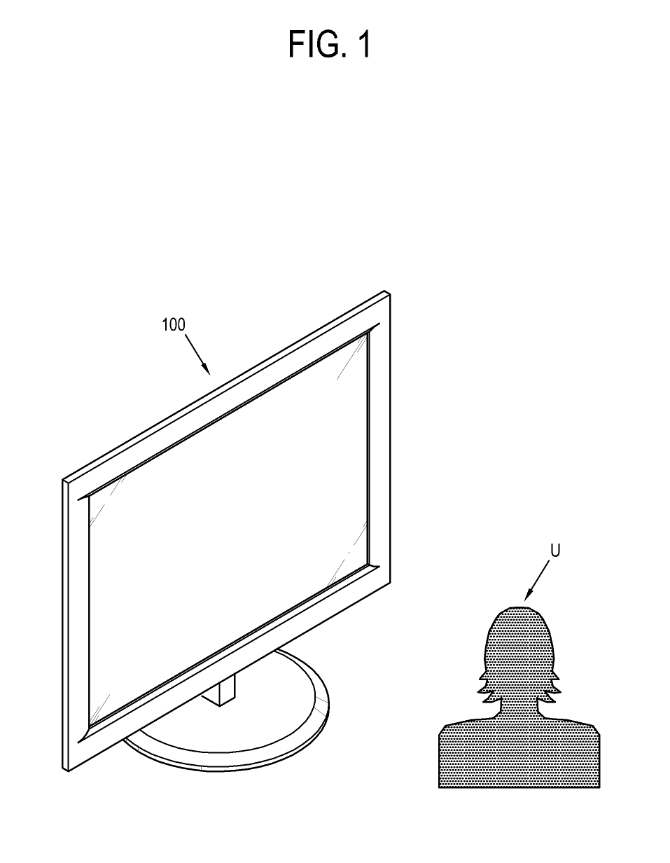

FIG. 1 illustrates an example of an image processing apparatus according to a first exemplary embodiment.

As shown in FIG. 1, the image processing apparatus 100 in this exemplary embodiment is a display apparatus which is capable of displaying an image. However, an exemplary embodiment may be applied to a set-top box or an image processing apparatus 100 that cannot display an image by itself. If the image processing apparatus 100 cannot display an image by itself, it may be locally connected with a separate external display apparatus so that the image can be displayed on the external display apparatus.

The display apparatus 100 not only processes image data received externally from, for example, a server or a user U in real time, but also stores the image data received from a storage which is located in the display apparatus 100, or stores data which is generated by recording an image which is currently displayed in the storage. The display apparatus 100 calls and processes the stored image to be displayed as an image.

Below, detailed configurations of the display apparatus 100 will be described.

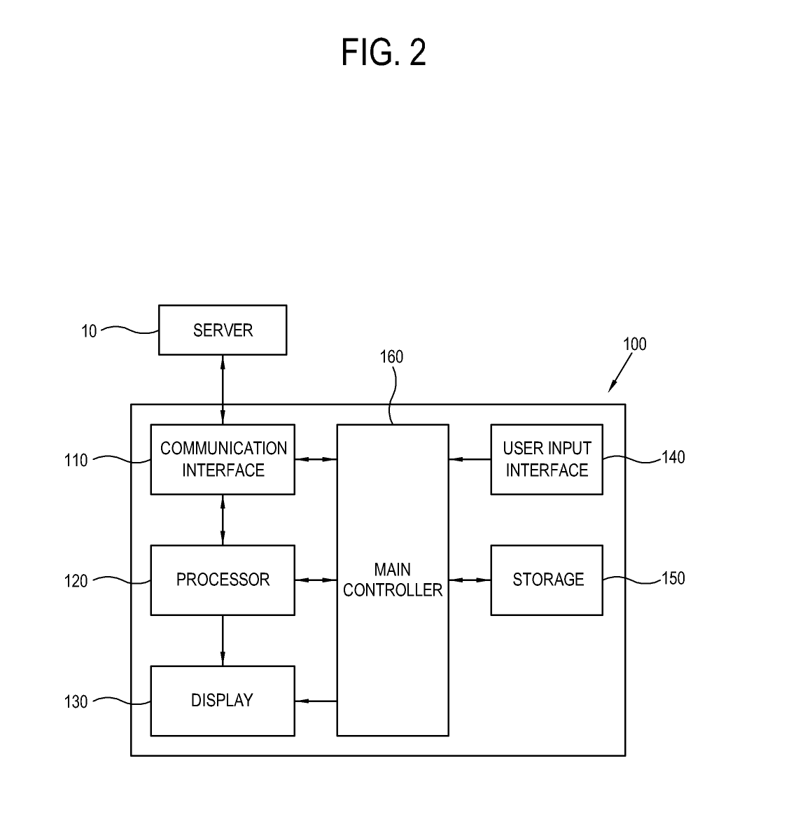

FIG. 2 is a block diagram of the display apparatus 100, according to an exemplary embodiment.

Referring to FIG. 2, the display apparatus 100 in the exemplary embodiment includes a communication interface 110 which communicates with an external device such a server 10 to transmit and receive data and/or a signal, a processor 120 which processes the data received in the communication interface 110 in accordance with a preset process, a display 130 which displays image data as an image if the data processed by the processor 120 is the image data, a user input interface 140 through which a user input operation is performed, a storage 150 which stores data and/or information, and a main controller 160 which controls general operations the display apparatus 100.

The communication interface 110 transmits and/or receives data so that interactive communication can be performed between the display apparatus 100 and a server 10 or other external devices (not shown). The communication interface 110 accesses the server 10 through a wired or wireless wide or local area networks or locally in accordance with preset communication protocols.

The communication interface 110 may be achieved by connection ports according to devices or an assembly of connection modules, in which the protocol for connection or a target for connection is not limited to one kind or type of server 10 or external device. The communication interface 110 may be internally provided in the display apparatus 100, but the exemplary embodiment is not limited thereto. Alternatively, the entire communication interface 110 or a part of the communication interface 110 may be added to the display apparatus 100 in the form of an add-on or dongle type.

The communication interface 110 transmits or receives a signal in accordance with protocols designated according to the connected devices, in which the signals can be transmitted or received based on individual connection protocols with regard to the connected devices. In the case of image data, the communication interface 110 may transmit or receive the signal bases on various standards such as a radio frequency (RF) signal standard, a composite/component video standard, a super video standard, a Syndicat des Constructeurs des Appareils Radiorécepteurs et Téléviseurs (SCART) standard, a high definition multimedia interface (HDMI) standard, a display port standard, a unified display interface (UDI) standard, or a wireless HD standard, etc.

The processor 120 performs various processes with regard to data or a signal which is received in the communication interface 110. If the communication interface 110 receives the image data, the processor 120 applies imaging process to the image data and the image data processed by this process is output to the display 130, thereby allowing the display 130 to display an image based on the corresponding image data. If the signal received in the communication interface 110 is a broadcasting signal, the processor 120 extracts video, audio and appended data from the broadcasting signal which is tuned to a certain channel, and adjusts an image to have a preset resolution, so that the image can be displayed on the display 130.

There is no limit to the kind of imaging processes which can be performed by the processor 120. For example, processes include decoding an image format of the image data, de-interlacing for converting the image data from an interlace type into a progressive type, scaling for adjusting the image data to have a preset resolution, noise reduction for improving image qualities, detail enhancement, frame refresh rate conversion, etc.

The processor 120 may perform various processes in accordance with the kind and attributes of the data, and thus the process to be implemented in the processor 120 is not limited to the imaging process. In addition, the data which can be processed in the processor 120 is not limited to only that which is received in the communication interface 110. For example, the processor 120 processes a user's speech in accordance with a preset voice process if a user inputs his or her speech through the user input interface 140, or processes a user's gesture in accordance with a preset gesture process if the user's gesture is sensed through the user input interface 140.

The processor 120 may be an image processing board (not shown) that a system-on-chip, where various functions are integrated, or an individual chip-set, capable of independently performing each process, is mounted on a printed circuit board. The processor 120 may be built in the display apparatus 100.

The display 130 displays the video signal or the image data processed by the processor 120 as an image. The display 130 can be any of various types of displays such as liquid crystal, plasma, a light-emitting diode, an organic light-diode, a surface-conduction electron-emitter, a carbon nano-tube and a nano-crystal, but the exemplary embodiments are not limited thereto.

The display 130 may additionally include an appended element based on the type of display 130. For example, in the case of the liquid crystal type, the display 130 may include a liquid crystal display (LCD) panel (not shown), a backlight unit (not shown) which emits light to the LCD panel, a panel driving substrate (not shown) which drives the panel, etc.

The user input interface 140 transmits a variety of preset control commands or information to the main controller 160 in accordance with a user's control or input. The user input interface 140 informationizes various events which have occurred in accordance with a user's intent and transmits the events to the main controller 160. Here, the events generated by a user may be given in many forms, for example, a user's control, speech, gesture, etc. Further, the user input may be received by, for example, a camera, a keyboard, a microphone, etc.

The storage 150 stores various pieces of data under the control of the main controller 160. The storage 150 is achieved by a nonvolatile memory such as a flash memory, a hard disk drive, etc. so as to retain data regardless of whether the system is powered on or off. The storage 150 is accessed by the processor 120 or the main controller 160 so that previously stored data can be read, recorded, modified, deleted, updated, and so on.

The main controller 160 is achieved by a central processing unit (CPU), and controls operations of the elements of the display apparatus 100, such as the processor 120, in response to an occurrence of a preset event. For example, if the communication interface 110 receives the image data of predetermined contents, the main controller 160 controls the processor 120 to process the image data to be displayed as an image on the display 130. In addition, if a user's input event occurs through the user input interface 140, the main controller 160 controls the processor 120 and the like elements to perform preset operations corresponding to the corresponding event.

With this configuration, the main controller 160 or the processor 120 accesses the storage 150 and thus reads or records the data from or in the storage 150. In this exemplary embodiment, the storage 150 is achieved by a hard disk drive having an interface complying with advanced technology attachment (ATA) standards, such as a serial advanced technology attachment (SATA).

The ATA is a standard for a computer bus to transmit data to a hard disk drive or an optical disk drive, and includes parallel ATA (PATA), serial ATA (SATA), etc. Recently, the SATA has been more widespread than the PATA since the SATA transmits data more quickly than the PATA.

However, the data stored in the storage 150 may be data whose content ownership belongs to a certain person, such as user authentication content, or data which is related to a user's privacy like a user profile. Therefore, many problems may arise if such data leaks to the third party.

For example, a service provider, which offers content service, may rent a set-top box or the display apparatus used as the image processing apparatus 100 to a customer in order to provide the service to the corresponding customer. In this case, a content producer or the service provider has content ownership and management responsibility with regard to the image data stored in the storage 150 of the set-top box, and the customer has authority for only viewing free content or paid content.

For instance, an unauthorized third-party may try to access the storage 150 by connecting an external device, which is an ATA capturing appliance or a hacking device for debugging, with the display apparatus 100 or may try to access a file system of the storage 150 by disconnecting the storage 150 from the display apparatus 100 and directly connecting the storage 150 to the external device. If the storage 150 is in an unlimited mode in which any separate security setting is not reflected, it is easy for the third party to acquire data from the storage 150 through the external device. This means that the data of which ownership belongs to a specific person leaks to an unauthorized third party.

If the data is profile data including a user's personal information, this means that the personal information can be leaked to the third party.

In order to prevent this, a secure structure should be applied to the interface of the storage 150 when a main processing system, including the processor 120 and the main controller 160 in the display apparatus 100, accesses the storage 150.

Below, the secure structure applied to the storage 150 will be described.

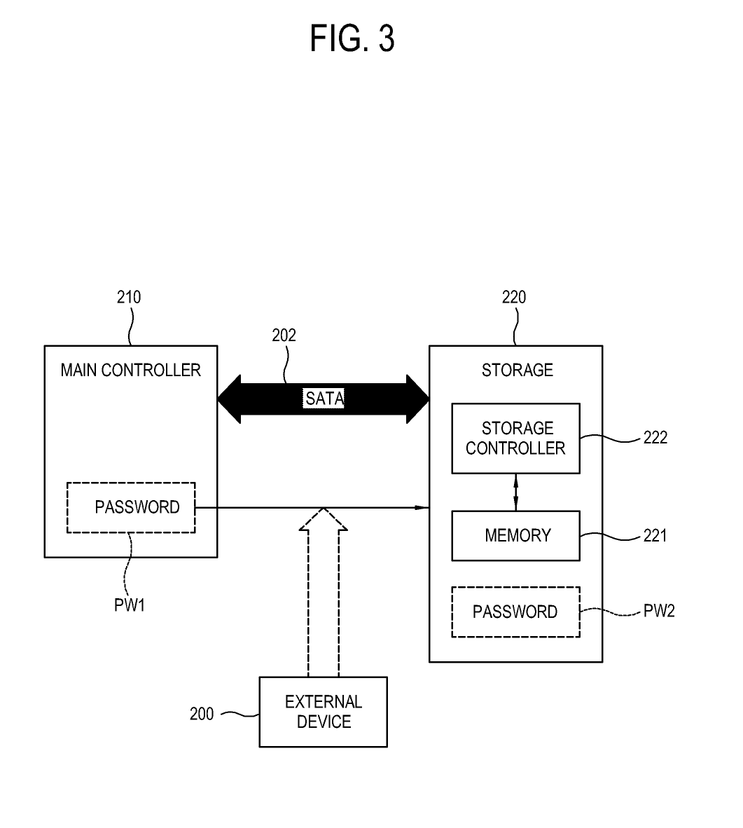

FIG. 3 is a block diagram showing a principle in which a main controller 210 accesses a storage 220 according to an exemplary embodiment.

As shown in FIG. 3, the main controller 210 can access the storage 220 through an interface 202 based on the ATA standards, for example, an SATA standard as shown in FIG. 3. In this exemplary embodiment, the main controller 210 and the storage 220 may respectively replace the main controller 160 and the storage 150 of FIG. 2 and be thus applied to the display apparatus 100.

The storage 220 includes a memory 221 in which data is actually stored, and a storage controller 222 for controlling operations performed in the storage 220 such as storing the data in the memory 221 and loading the data from the memory 221. The storage controller 222 performs a preset operation for the memory 221 in response to a command received from the main controller 210, and returns operation results to the main controller 210.

For example, if the main controller 210 transmits a command requesting certain data from the storage 220, the storage controller 222 retrieves the corresponding data within the memory 221 in response to the command, and transmits the retrieved data to the main controller 210. In addition, if the main controller 210 transmits a command for modifying the certain data to the storage 220, the storage controller 222 retrieves the corresponding data within the memory 221 in response to the command, modifies the retrieved data in accordance with the command, and transmits the modification results to the main controller 210.

If the storage 220 is in the unlimited mode without any secure setting for the SATA interface of the storage 220, the storage 220 can be accessed by the main controller 210 without any restriction.

In accordance with the ATA standards, secure reference commands that can be transmitted from the main controller 210 to the storage 220 include “lock” and “unlock”. Thus, the main controller 210 may apply the security setting to the storage 220 as follows.

The main controller 210 transmits a “lock” command with a preset password PW2 to the storage 220. The main controller 210 may autonomously include a memory (not shown) for storing the password PW2. Such a memory is different from the storage 220.

The storage controller 222 stores the password PW2 received from the main controller 210 in the storage 220, and converts the unlimited mode of the storage into a locked mode in accordance with the “lock” command.

When the storage 220 is in the locked mode, the storage 220 refuses any external access to the storage 220 through the SATA standard interface of the storage 220. That is, if the storage 220 is in the locked state, the data stored in the memory 221 is not transmitted outside of the storage 220.

If the access to the storage 220 is accepted and access to the data stored in the memory 221 is desired, the locked mode of the storage 220 has to be converted into an unlocked state.

The main controller 210 transmits an “unlock” command with a password PW1 to the storage 220 which is in the locked state. The storage controller 222 compares the password PW1 received from the main controller 210 with the password PW2 previously stored in the storage 220, and converts the locked mode of the storage 220 into the unlocked mode in accordance with the “unlock” command if both the passwords match.

The storage 220 which is in the unlocked mode accepts the access to the storage 220 and is then in an unlimited state. The unlocked mode of the storage 220 is maintained while the system power of the display apparatus 100 is turned on, i.e., while power is supplied to the storage 220. If the system power of the display apparatus 100 is first turned off and then turned on, the storage 220 returns to the locked state.

That is, when the main controller 210 with the password PW1 accesses the storage 220, the storage 220 is converted from the locked mode to the unlocked mode and thus accepts the access.

However, such passwords PW1 and PW2 may be leaked to the third party in the following cases.

There may be two cases where the main controller 210 transmits the previously stored password PW2 to the storage 220 in order to first convert the storage 220 into the locked mode and where the main controller 210 transmits the password PW1 to the storage 220 in order to convert the storage 220 into the unlocked state. In these two cases, if an external device 200, which has a debugging function, can determine the flow of the data by capturing the transmitted data, intercepts the data transmitted between the main controller 210 and the storage 220, the passwords PW1 and PW2 are intercepted in a data leak by the external device 200.

If the passwords PW1 and PW2 leak, the external device 200 can access the storage 220 by transmitting the “unlock” command with the passwords PW1 and PW2 to the storage 220, thus converting the storage 220 into an unlocked state.

A second exemplary embodiment, which addresses the problem of leaking the passwords, will be described below.

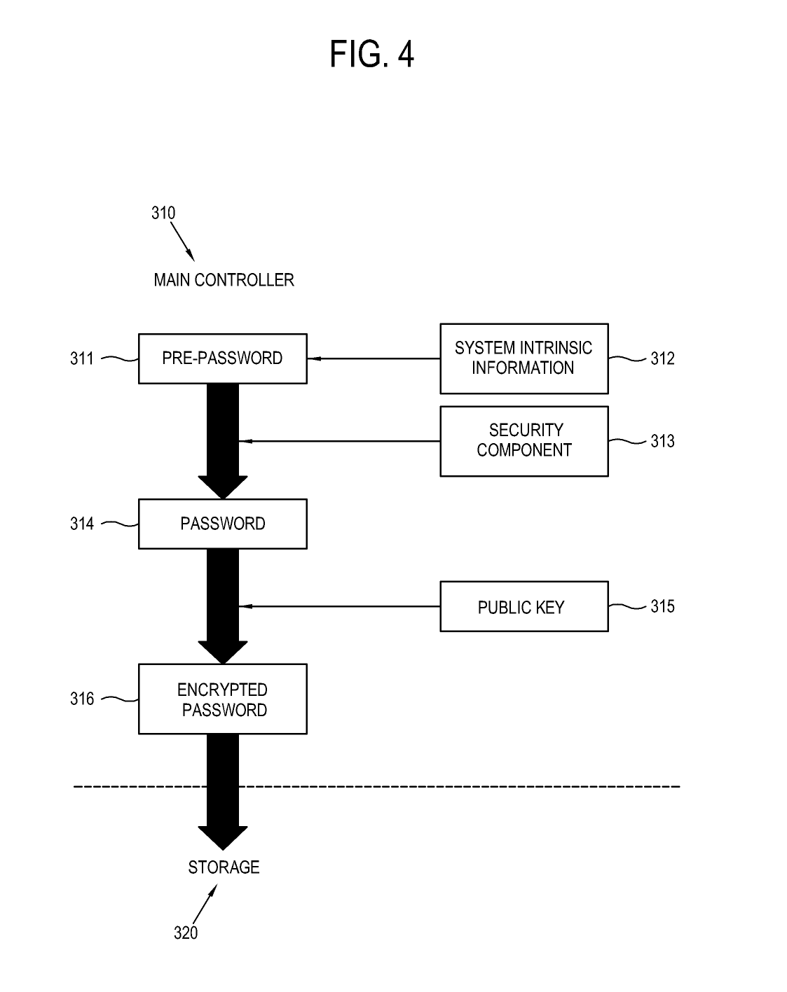

FIG. 4 shows an example of generating a password 314 for setting a storage 320 into a locked mode by a main controller 310 in a display apparatus according to an exemplary embodiment. In this exemplary embodiment, the main controller 310 and the storage 320 may respectively replace the main controller 160 and the storage 150 of FIG. 2 and be thus applied to the display apparatus 100.

As shown in FIG. 4, the main controller 310 first generates a pre-password 311. The pre-password 311 is generated based on system intrinsic information 312 of the display apparatus 100, and thus has an effect on limiting a target accessible in the storage 320 by the main controller 310.

The system intrinsic information 312 of the display apparatus 100 may include at least one of a CPU identification (ID) of the main controller 310, a media access control (MAC) address of the display apparatus 100, and a serial number of the display apparatus 100.

The main controller 310 converts the pre-password 311 into the password 314 by applying a security component 313 of the display apparatus to the pre-password 311. The security component 313 may be an encryption algorithm previously set for converting the pre-password 311 of a simple character string into the password 314 of higher security level, and may employ a data encryption standard (DES), advanced encryption standard (AES) or the like standard algorithm.

The foregoing procedures for generating the password 314 are merely examples, and various methods may be used to generate the password 314 for setting the storage 320 to the locked state.

In the first exemplary embodiment, the main controller 310 directly transmits a generated password 314 to the storage 320, and converts the mode of the storage 320 into the locked state.

However, in the second exemplary embodiment, the main controller 310 applies a preset public key encryption algorithm, i.e. a Public Key cryptosystem algorithm to the password 314, and thus converts the password 314 into an encrypted password 316. That is, the main controller 310 encrypts the password 314 again with a public key 315, thereby generating the encrypted password 316.

In this exemplary embodiment, the public key cryptosystem algorithm uses a Rivest-Shamir-Adleman (RSA) method, but this is merely an example and the exemplary embodiments are not limited thereto. Alternatively, another system, i.e. an elliptic curve cryptosystem (ECC) using a public key and a private key may be used.

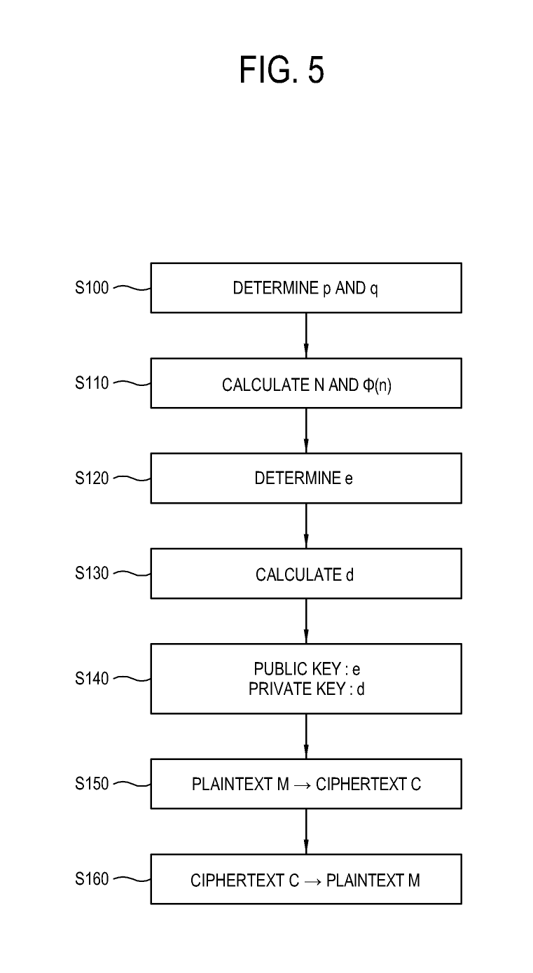

Below, a principle of encrypting and decrypting the data by an RSA method will be described with reference to FIG. 5.

FIG. 5 is a flowchart illustrating an example of encrypting and decrypting the data by the RSA method, according to an exemplary embodiment.

As shown in FIG. 5, a plain text M is encrypted into a ciphertext C based on an RSA algorithm, and this ciphertext C is decrypted into the plaintext M again.

If there is a result value from multiplication between two primes, it is easy to obtain the result value by multiplying the two primes. On the other hand, it is very difficult for two primes which are used to obtain the result value to be calculated from the result value. This means that reverse calculation is mathematically difficult. Taking the difficulty of the prime factorization into account, the RSA algorithm applies the concept of the prime factorization to the encryption. In this regard, the public key is needed for the encryption of the plain text, and the private key is needed for the decryption of the ciphertext.

The private key and the public key are generated by the following procedures.

At operation S100, sufficiently large primes p and q are first determined. The larger the large primes p and q, the more stable the encryption.

If p and q are determined, at operation S110 an RSA modulus n and a Euler's phi function Φ(n) are calculated, where n satisfies n=p*q, and Φ(n) satisfies Φ(n), (p−1)(q−1).

At operation S120, an arbitrary value e is determined, where e satisfies 1<e<Φ(n) and is a prime relative to Φ(n).

At operation S130, d is calculated in accordance with the determination of e, where d is a value of satisfying [e*d≡1 (mod Φ(n))] and mod is an modulus operator.

In this manner, if n, e and d are determined, at operation S140, e is set to the public key and d is set to the private key.

At operation S150, a ciphertext provider encrypts the plaintext M into the ciphertext C with the public key by a method of [C=Me mod n] and transmits the ciphertext C to the plaintext decipherer.

At operation S160, the plaintext decipherer decrypts the ciphertext C into the plaintext M with the private key by a method of [M=Cd mod n]. That is, since the public key is open, the plaintext decipherer can decrypt the ciphertext C if the plaintext decipherer has only the private key.

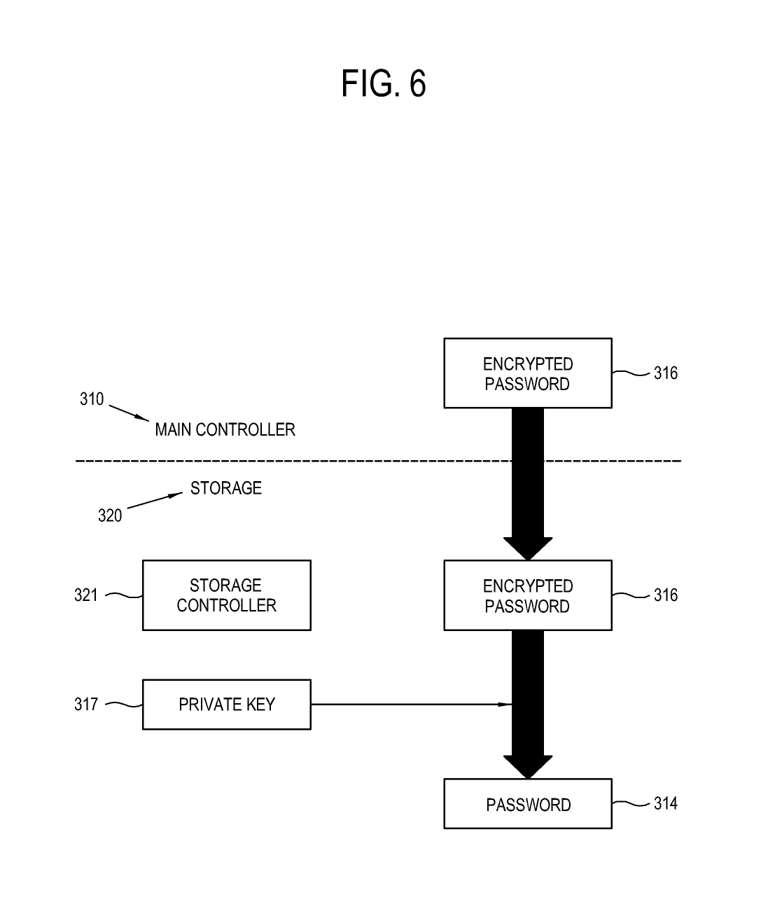

FIG. 6 shows an example in which the storage 320 enters a locked mode as the storage of an unlimited mode receives and stores the password 314, according to an exemplary embodiment.

As shown in FIG. 6, a storage controller 321 of the storage 320 receives the encrypted password 316 from the main controller 310. The storage controller 321 uses a previously stored private key 317 to decrypt the encrypted password 316 into the password 314.

The private key 317 is provided corresponding to the public key 315 of FIG. 4, and is previously stored in the storage 320. The corresponding private key 317 may be stored in the storage 320 when the storage 320 is manufactured, or may be previously designated and stored by the main controller 310.

The storage controller 321 stores the decrypted password 314 in the storage 320, and converts the mode of the storage 320 into the locked state.

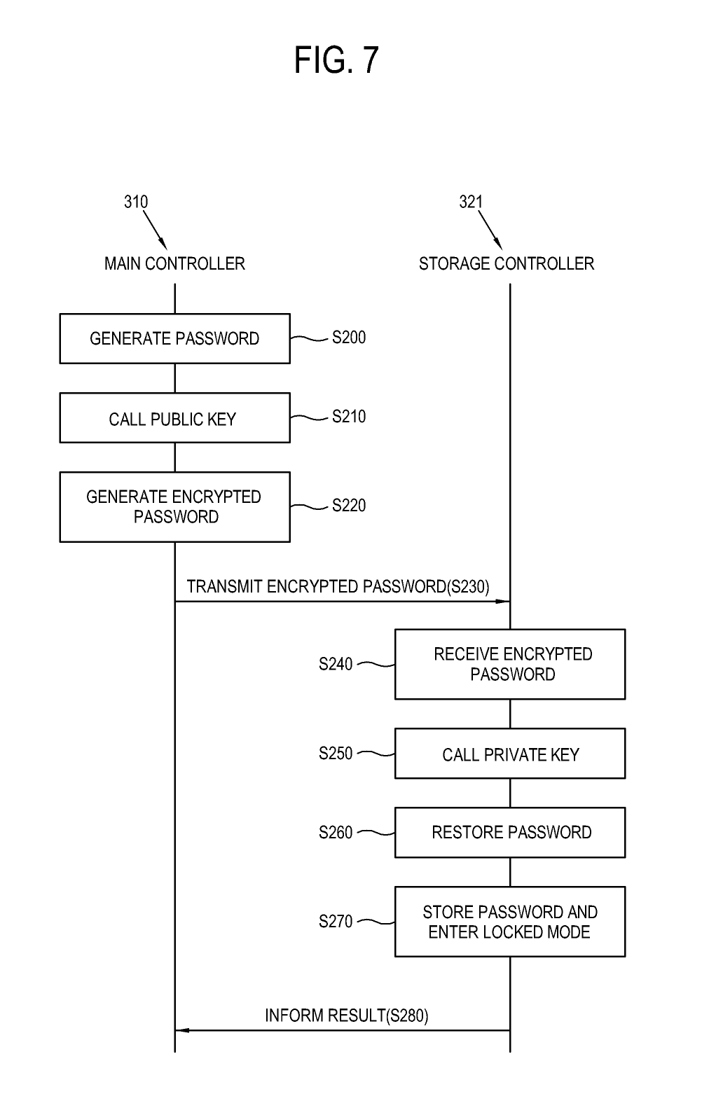

FIG. 7 shows operations performed between the main controller 310 and a storage controller 321 when the storage 320 enters the locked state, according to an exemplary embodiment.

As shown in FIG. 7, at operation S200 the main controller 310 generates a password. The password may be generated using the system intrinsic information and the security component as described with reference to FIG. 4, or can be generated by various other methods.

The main controller 310 calls the public key at operation S210, and encrypts the password with the public key at operation S220, thereby generating the encrypted password. In this exemplary embodiment, the main controller 310 has the public key, and the storage controller 321 has the private key corresponding to the public key.

At operation S230 the main controller 310 transmits the encrypted password to the storage controller 321.

At operation S240 the storage controller 321 receives the encrypted password. The storage controller 321 calls the private key at operation S250, and decrypts the encrypted password with the private key at operation S260, thereby restoring the password. At operation S270 the storage controller 321 stores the restored password and converts the mode of the storage 320 into the locked state.

At operation S280 the storage controller 321 informs the main controller 310 that the storage 320 enters the locked state.

Even if the third party intercepts the encrypted password during operation S230 of transmitting the encrypted password, the third party cannot decrypt the encrypted password since the password itself is encrypted and the third party has no private key. According to an exemplary embodiment, it is possible to prevent leakage of the password set for limiting the access to the storage 320.

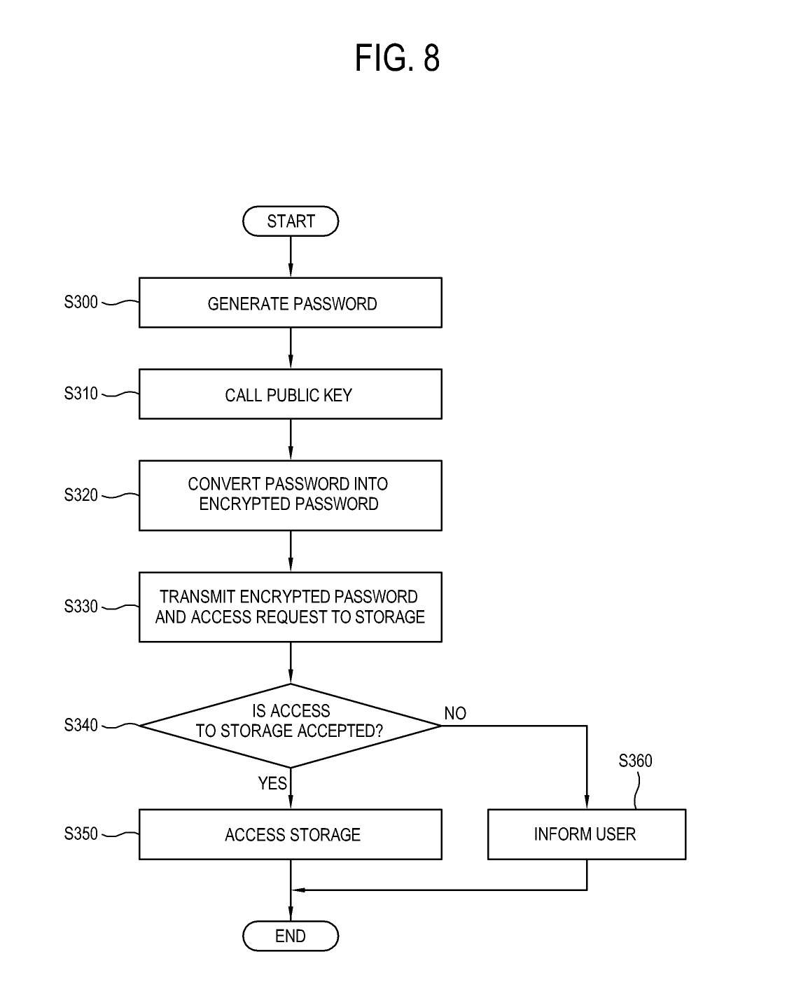

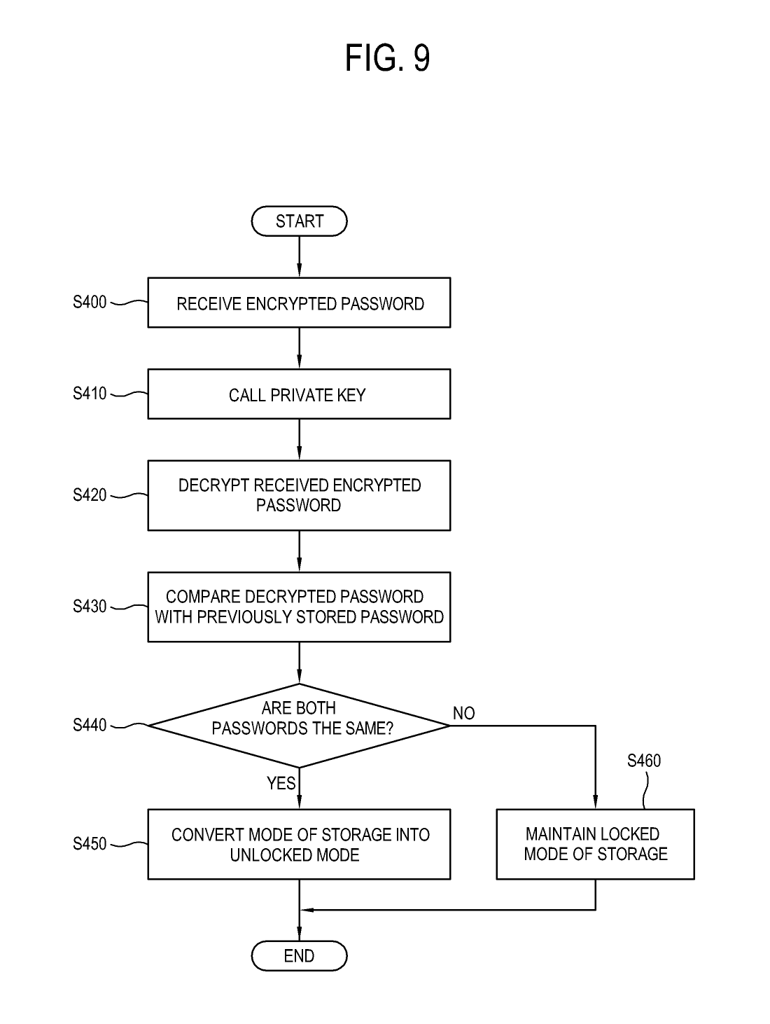

Below, processes where the main controller 310 controls the storage 320 to enter the unlocked mode and accesses the storage 320 will be described with reference to FIGS. 8 and 9. In this exemplary embodiment, the storage 320 is initially in the locked state.

FIG. 8 is a flowchart showing a process where the main controller 310 accesses the storage 320 which is in a locked state, according to an exemplary embodiment, and FIG. 9 is a flowchart showing a process where the storage controller 321 accepts or refuses a request for the access of the main controller 310 to the storage 320 of the locked state, according to an exemplary embodiment.

As shown in FIG. 8, at operation S300 the main controller 310 generates a password. The main controller 310 calls the previously stored public key at operation S310, and converts the password into the encrypted password S320 with the public key.

Operations S300 to S320 are performed by the same algorithm as those of generating the encrypted password by the main controller 310 as described in operations S200-S220 in FIG. 7. This is performed so as not to store the encrypted password generated in the foregoing operation S220 of FIG. 7 in a separate memory by the main controller 310. If the encrypted password is stored in a separate memory, the encrypted password may be leaked to the third party. Therefore, the main controller 310 repeats the process of generating the encrypted password whenever the main controller 310 accesses the storage 320.

At operation S330 the main controller 310 transmits the encrypted password and the access request to the storage 320. If the access request to the storage 320 is allowed at operation S340, the main controller 310 accesses the storage 320 at operation S350. On the other hand, if the access request to the storage 320 is not allowed at operation S340, the main controller 310 informs a user of the current status at operation S360.

As shown in FIG. 9, at operation S400 the storage controller 321 receives the encrypted password from the main controller 310. The storage controller 321 calls the private key at operation S410, and decrypts the previously received encrypted password at operation S420.

At operation S430, the storage controller 321 compares the decrypted password with the previously stored password.

At operation S440, the storage controller 321 determines whether the two passwords are equal or match each other. If it is determined that these two passwords are equal or match each other, the storage controller 321 converts the mode of the storage 320 to the unlocked mode at operation S450. On the other hand, it is determined that these two passwords are not equal or do not match each other, the storage controller 321 maintains the locked mode of the storage 320 at operation S460.

In brief, the storage 320 stores the data and the preset first password and is converted from the locked mode for refusing access by the data processor 120 to the unlocked mode for accepting access by the data processor 120 so that the data can be processed if the second password received from the controller 310 is equal to the first password.

The controller 310 includes a memory (not shown) for storing the second password, and transmits the second password to the storage 320 so that the storage 320 can be converted from the locked mode to the unlocked mode. The controller encrypts the second password using the preset public key based on the public key encryption algorithm and transmits the encrypted second password to the storage 320, thereby controlling the storage 320 with the private key corresponding to the public key to decrypt the encrypted second password using the corresponding private key.

According to an exemplary embodiment, the main controller 310 designates the password and transmits the designated password to the storage 320 so that the storage 320 can enter the locked mode and thus the password can be transmitted to the storage 320 in the locked mode, thereby controlling the storage 320 to enter the unlocked mode. When transmitting the password to the storage 320, the main controller 310 encrypts the password with the preset public key based on the public key cryptosystem algorithm and transmits the encrypted password to the storage 320.

Thus, the storage controller 321 decrypts the encrypted password based on the previously stored private key so as to correspond to the public key.

The storage controller 321 stores the decrypted password, thereby controlling the storage 320 to enter the locked mode.

Further, the storage controller 321 compares the first password restored from the encrypted password with the previously stored second password when the storage 320 receives the encrypted password in the locked mode, and controls the storage 320 to enter the unlocked mode if both passwords are the same and maintain the locked mode of the storage 320 if both are different.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. An image processing apparatus comprising:
a data processor configured to process data;
a storage configured to store the data and a preset first password, and configured to be converted from a locked mode which denies the data processor access to the storage to an unlocked mode which permits the data processor to access the storage so that the data can be processed if a second password which is received matches the first password; and
a main controller comprising a controller memory configured to store the second password, and transmit the second password to the storage so that the storage can be converted from the locked mode to the unlocked mode,
wherein the main controller encrypts the second password with a preset public key based on a public key encryption algorithm and transmits the encrypted second password to the storage so that the storage which has a private key corresponding to the public key can decrypt the encrypted second password with the private key.

2. The image processing apparatus according to claim 1, wherein the storage further comprises a storage controller configured to control operations of the storage in response to a command from the main controller, and
wherein the storage controller is configured to control the second password which is decrypted from the encrypted second password which is stored as the first password if the storage does not store the first password, and the encrypted second password is received from the main controller, and controls the storage to enter the locked mode.

3. The image processing apparatus according to claim 2, wherein the storage controller is configured to maintain the locked mode of the storage if the decrypted second password does not match the first password.

4. The image processing apparatus according to claim 1, wherein the main controller is configured to delete the encrypted second password after the encrypted second password is transmitted to the storage if the encrypted second password is generated based on the second password stored in the controller memory.

5. The image processing apparatus according to claim 1, wherein the public key encryption algorithm comprises a Rivest-Shamir-Adleman (RSA) method or an elliptic curve cryptosystem (ECC) method.

6. The image processing apparatus according to claim 1, wherein the main controller is configured to generate the second password based on system intrinsic information of the image processing apparatus.

7. The image processing apparatus according to claim 6, wherein the system intrinsic information comprises at least one of a central processing unit identification (CPU ID) of the main controller, a media access control (MAC) address of the image processing apparatus, and a serial number of the image processing apparatus.

8. The image processing apparatus according to claim 6, wherein the main controller is configured to generate a pre-password from the system intrinsic information of the image processing apparatus, and configured to convert the pre-password into the second password based on a data encryption standard (DES) or an advanced encryption standard (AES).

9. The image processing apparatus according to claim 1, wherein the controller and the data processor have access to the storage through an advanced technology attachment (ATA) standard interface.

10. A method of controlling an image processing apparatus comprising a storage configured to store data and a preset first password, a data processor configured to access the storage and process the data, and a main controller configured to control an operation mode of the storage, the method comprising:
operating, by the storage, in a locked mode in which access by the data processor to the storage is denied;
transmitting, by the main controller, a previously stored second password to the storage;
entering, by the storage, an unlocked mode which permits access by the data processor to the storage so that the data can be processed if the second password matches the first password; and
accessing, by the data processor, the storage which is in the unlocked mode and processing the data stored in the storage,
wherein the main controller is configured to transmit the previously stored second password to the storage by encrypting the second password with a preset public key based on a public key encryption algorithm, and
wherein the storage is converted from the locked mode to the unlocked mode when the storage having a private key corresponding to the public key decrypts the encrypted second password with the private key.

11. The method according to claim 10, further comprising storing the second password decrypted from the encrypted second password as the first password if the storage does not store the first password and the encrypted second password is received from the main controller, and controlling the storage to enter the locked mode.

12. The method according to claim 11, further comprising maintaining the locked mode of the storage if the decrypted second password does not match the first password.

13. The method according to claim 10, wherein the transmitting the previously stored second password to the storage by the main controller further comprises deleting the encrypted second password from the main controller after the main controller transmits the encrypted second password to the storage.

14. The method according to claim 10, wherein the public key encryption algorithm comprises a Rivest-Shamir-Adleman (RSA) method or an elliptic curve cryptosystem (ECC) method.

15. The method according to claim 10, further comprising generating, by the main controller, the second password based on system intrinsic information of the image processing apparatus.

16. The method according to claim 15, wherein the system intrinsic information comprises at least one of a central processing unit identification (CPU ID) of the main controller, a media access control (MAC) address of the image processing apparatus, and a serial number of the image processing apparatus.

17. The method according to claim 10, wherein the generating the second password by the main controller based on the system intrinsic information of the image processing apparatus comprises:
generating a pre-password from the system intrinsic information of the image processing apparatus; and
converting the pre-password into the second password based on a data encryption standard (DES) or an advanced encryption standard (AES).

18. The method according to claim 10, wherein the main controller and the data processor access the storage through an advanced technology attachment (ATA) standard interface.
